(19) United States
(12) Patent Application Publication
(10) Pub. No.: US 2006/0262701 A1
(43) Pub. Date: Nov. 23, 2006

(54) Information recording apparatus, information reproducing apparatus and information recording/reproducing apparatus, according to hologram method

(75) Inventors: Kuniaki Okada, Tenri-shi (JP); Yukio Kurata, Tenri-shi (JP); Tetsuo Saeki, Ibaraki-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/434,428

(22) Filed: May 11, 2006

(30) Foreign Application Priority Data
May 13, 2005 (JP) 2005-141394 (P)
Jan. 6, 2006 (JP) 2006-001766 (P)

(51) Int. Cl. G11B 7/00

(52) U.S. Cl. 369/103

(57) ABSTRACT

A holographic recording/reproducing apparatus controls a position and an area size of a signal light and/or a reference light in a holographic recording medium by a spatial light amplitude modulator. Thus, the holographic recording/reproducing apparatus can set the position and the area size of the signal light and/or the reference light arbitrarily by using a spatial light amplitude modulator of high resolution as the spatial light amplitude modulator. Further, by controlling the position of the reference light by the spatial light amplitude modulator, the holographic recording/reproducing apparatus can change the incident angle on the holographic recording medium. Angle multiplex recording can thus be realized.

This nonprovisional application is based on Japanese Patent Applications Nos. 2005-141394 and 2006-001766 filed with the Japan Patent Office on May 13, 2005 and Jan. 6, 2006, respectively, the entire contents of which are hereby incorporated by reference.

### BACKGROUND OF THE INVENTION

1. Field of the Invention

The present invention relates to an information recording apparatus, an information reproducing apparatus and an information recording/reproducing apparatus, and more particularly, to an information recording apparatus, an information reproducing apparatus and an information recording/reproducing apparatus that record interference fringes of an object light and a reference light on a holographic recording medium and/or reproduce information.

2. Description of the Background Art

Recording of information on a recording medium by using holography, i.e., holographic recording, is generally performed by superposing a light containing image information with a reference light in a holographic recording medium, and by writing interference fringes obtained at that time on the holographic recording medium. When reproducing the recorded information, the holographic recording medium is irradiated with a reference light to reproduce image information by diffraction of the interference fringes, and the image information is subjected to image processing to obtain a reproduction signal. The interference fringes are written into the holographic recording medium in three dimensions, and storage capacity of the holographic recording medium can be increased by multiplex recording.

Various multiplexing methods for holographic recording have been proposed, which include angle multiplexing, spatial shift multiplexing, and peristrophic multiplexing.

As for the angle multiplexing method, one reported on page 34 of the technical digest of ISOM 04 is known (Kevin Curtis et al., “High Density Holographic Storage”, International Symposium on Optical Memory 2004, Technical Digest, p. 34). According to the angle multiplexing method, an information light converged by a lens interferes with a reference light of plane wave on a holographic recording medium, for holographic recording. More specifically, a galvanometer mirror is used to deflect the reference light, and the angle between the information light and the reference light is changed to carry out multiplex recording.

As for the spatial shift multiplexing method, one disclosed in Japanese Patent No. 3452113 is known. According to the spatial shift multiplexing method, an information light and a reference light having different convergence points in the thickness direction of the holographic recording medium interfere with each other on the holographic recording medium, for holographic recording. With this method, since the reference light is spherical wave, different information light interference patterns can be recorded by shifting the convergence point in the in-plane direction, whereby multiplex recording can be realized.

As for the peristrophic multiplexing method, one disclosed in Japanese Patent Laying-Open No. 2000-338846, for example, is known. With this method, a reference light is rotated in the conical plane with its apex on a holographic recording medium. Thus, this can be said to be a kind of angle multiplexing method. According to this method, the information light is irradiated in the direction of normal line to the surface of the holographic recording medium.

A conventional example utilizing the angle multiplexing method uses, as deflecting means of the reference light, mechanical means such as a galvanometer mirror, or electrically controlling means such as an optoacoustic deflector, electro-optic deflector or the like. However, the galvanometer mirror poses problems in terms of reproducibility, such as backlash, precision in resolution, and stability with respect to disturbance. The optoacoustic deflector and the electro-optic deflector are poor in resolution. Further, the elements of these deflecting means are expensive.

The angle multiplexing method also poses a problem that it is difficult to guide the reference light to a desired position of the holographic recording medium, since the traveling direction of the reference light is controlled with respect to the position of the deflecting means set as the center. Further, since the angle multiplexing method involves the configuration where the reference light and the information light are completely separated into two light fluxes to cause interference therebetween on the holographic recording medium, complicated optical adjustment of the light fluxes would be required upon assembly of the device.

In a conventional example utilizing the spatial shift multiplexing method, the positional relationship between the reference light and the information light in the thickness direction of the holographic recording medium is fixed. Thus, with the spatial shift multiplexing method, an increase in thickness of the holographic recording medium would not lead to an increase of recording density, so that there is a limit of the recording capacity achievable by the holographic recording medium.

In a conventional example utilizing the peristrophic multiplexing method, the means for forming the reference light is complex. Thus, it is difficult to adopt the same to a holographic recording medium of a rotary optical disk type.

### SUMMARY OF THE INVENTION

An object of the present invention is to provide an information recording apparatus, an information reproducing apparatus, and an information recording/reproducing apparatus that can perform high-density multiplex recording without the need of complicated optical adjustment.

The present invention provides an information recording apparatus recording information on a holographic recording medium, which includes: a light flux control element splitting light emitted from a light source into a reference light and a signal light, and controlling a position and an area size of the reference light and/or a position and an area size of the signal light in the holographic recording medium; and a lens guiding the signal light and the reference light to the same area of the holographic recording medium.

Preferably, it further includes a light deflecting element deflecting the reference light to control an interference position of the reference light and the signal light in the holographic recording medium.

According to another aspect of the present invention, there is provided an information recording apparatus recording information on a holographic recording medium, which includes: a first diffracting element splitting light emitted from a light source into a reference light and a signal light; a light flux control element controlling a position and an area size of the reference light and/or a position and an area size of the signal light in the holographic recording medium; and a lens focusing the signal light and the reference light on the same area of the holographic recording medium.

According to yet another aspect of the present invention, there is provided an information reproducing apparatus reproducing information from a holographic recording medium, which includes: a light flux control element forming a reference light by light emitted from a light source, and controlling a position and an area size of the reference light in the holographic recording medium; and a lens guiding the reference light to the holographic recording medium.

Preferably, it further includes a light deflecting element deflecting the reference light to control an incident angle of the reference light on the holographic recording medium.

According to yet another aspect of the present invention, there is provided an information recording/reproducing apparatus recording/reproducing information with respect to a holographic recording medium, which includes: a light flux control element splitting light emitted from a light source into a reference light and a signal light at the time of recording, and controlling a position and an area size of the reference light and/or a position and an area size of the signal light in the holographic recording medium; and a lens guiding the signal light and the reference light to the same area of the holographic recording medium at the time of recording, and guiding the reference light to the holographic recording medium at the time of reproduction.

Preferably, the light flux control element includes at least one of a spatial light modulator, a light shutter, a movable diffraction grating, and a movable mask.

Preferably, it further includes an actuator servo-controlling the lens in an optical axis direction in response to vibration of the holographic recording medium.

Preferably, the lens includes a lens portion arranged at a central portion, and a diffraction grating portion arranged at a peripheral portion and having a grating pitch set to diffract the reference light toward an area in the holographic recording medium irradiated with the signal light.

Preferably, it further includes a light deflecting element deflecting the reference light to control an interference position of the reference light and the signal light in the holographic recording medium.

Preferably, the light deflecting element includes at least one of a spatial light phase modulator, a movable diffraction grating, and a movable prism.

Preferably, the movable diffraction grating has either one diffraction grating pattern rotated or moved, or a plurality of diffraction grating patterns, and a desired diffraction grating pattern is selected therefrom by rotating the movable diffraction grating.

Preferably, the movable prism has a central portion through which the signal light passes processed into a flat plate shape, and a peripheral portion through which the reference light passes processed into a prism shape, and includes a plurality of areas in the peripheral portion having prism angles gradually changed.

Preferably, the reference light incident on the holographic recording medium is a convergent light or a divergent light.

Preferably, the reference light incident on the holographic recording medium is a plane wave.

Preferably, the signal light incident on the holographic recording medium is a convergent light or a divergent light.

According to yet another aspect of the present invention, there is provided an information recording/reproducing apparatus recording/reproducing information with respect to a holographic recording medium, which includes: a first diffracting element splitting light emitted from a light source into a reference light and a signal light at the time of recording; a light flux control element controlling a position and an area size of the reference light and/or a position and an area size of the signal light in the holographic recording medium; and a lens focusing the signal light and the reference light on the same area of the holographic recording medium at the time of recording, and focusing the reference light on the holographic recording medium at the time of reproduction.

Preferably, the light flux control element is a spatial light amplitude modulator, and a position of the reference light in a pupil plane of the lens is controlled by rotation of the first diffracting element and by the spatial light amplitude modulator.

Preferably, it further includes a second diffracting element including a plurality of diffraction grating patterns diffracting the reference light, wherein the plurality of diffraction grating patterns are selected by rotating the second diffracting element, so as to control an incident angle and an incident position of the reference light on the holographic recording medium.

Preferably, the first diffracting element includes a diffraction grating portion having diffraction efficiency optimized such that energy densities of the signal light and the reference light become equal to each other in an interference fringe forming area of the holographic recording medium.

Preferably, the first diffracting element splits the light emitted from the light source into first and second reference lights and the signal light at the time of recording, the light flux control element is a movable prism having a central portion through which the signal light passes processed into a flat plate shape, and a peripheral portion through which the reference light passes processed into a prism shape, and including a plurality of areas in the peripheral portion having prism angles gradually changed, and one of the gradually changing prism angles is selected by rotating the movable prism, so as to control incident angles and incident positions of the first and second reference lights on the holographic recording medium.

According to the present invention, it is possible to perform high-density multiplex recording without the need of complicated optical adjustment.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view showing a schematic configuration of a holographic recording/reproducing apparatus 100 according to a first embodiment of the present invention.

FIG. 2 shows positional relationship between a signal light 12 and a reference light 13 in a pupil plane of an objective lens 6 in holographic recording/reproducing apparatus 100 in FIG. 1.

FIG. 3 shows a change in diffraction efficiency of a reproduction light when the position of reference light 13 is rotated in a radial direction in the pupil plane of objective lens 6.

FIG. 4 is a cross sectional view showing a schematic configuration of a holographic recording/reproducing apparatus 200 according to a second embodiment of the present invention.

FIG. 5 shows positional relationship between signal light 12 and reference light 13 in the pupil plane of a compound lens 21 in holographic recording/reproducing apparatus 200 in FIG. 4.

FIG. 6 shows an example as to how the holographic recording medium 7 is irradiated with signal light 12 and reference light 13 in holographic recording/reproducing apparatus 200 in FIG. 4.

FIG. 7 shows another example as to how holographic recording medium 7 is irradiated with signal light 12 and reference light 13 in holographic recording/reproducing apparatus 200 in FIG. 4.

FIG. 8 is a cross sectional view showing a schematic configuration of a holographic recording/reproducing apparatus 300 according to a third embodiment of the present invention.

FIG. 9 is a top plan view showing a configuration of a diffracting element 31 in holographic recording/reproducing apparatus 300 in FIG. 8.

FIG. 10 is a top plan view showing a configuration of a diffracting element 33A as an example of a diffracting element 33 in FIG. 8.

FIG. 11 is a top plan view showing a configuration of a diffracting element 33B as another example of diffracting element 33 in FIG. 8.

FIG. 12 is a cross sectional view showing a schematic configuration in one cross section of a holographic recording/reproducing apparatus 400 according to a fourth embodiment of the present invention.

FIG. 13 is a top plan view showing a configuration of a diffracting element 41 in holographic recording/reproducing apparatus 400 in FIG. 12.

FIG. 14 is a bottom plan view showing the configuration of diffracting element 41 in holographic recording/reproducing apparatus 400 in FIG. 12.

FIG. 15 is a top plan view showing a configuration of a prism element 45 in holographic recording/reproducing apparatus 400 in FIG. 12.

FIG. 16 is a cross sectional view showing a schematic configuration in another cross section of holographic recording/reproducing apparatus 400 according to the fourth embodiment of the present invention.

### DESCRIPTION OF THE PREFERRED EMBODIMENTS

Hereinafter, embodiments of the present invention will be described in detail with reference to the drawings. In the drawings, the same or corresponding portions have the same reference characters allotted, and description thereof will not be repeated.

### First Embodiment

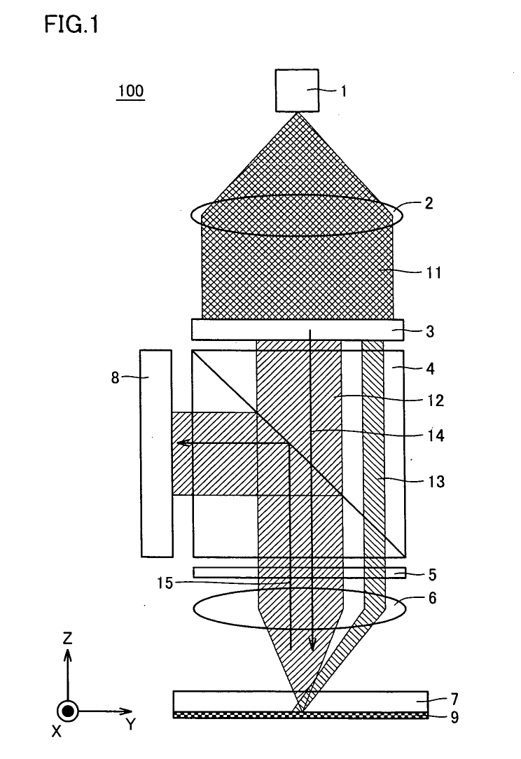

FIG. 1 is a cross sectional view showing a schematic configuration of a holographic recording/reproducing apparatus 100 according to the first embodiment of the present invention. Referring to FIG. 1, the holographic recording/reproducing apparatus (information recording/reproducing apparatus) 100 of the first embodiment includes a laser 1, a collimate lens 2, a spatial light amplitude modulator 3, a polarizing beam splitter 4, a quarter wave plate 5, an objective lens 6, and an image pickup element 8. Holographic recording/reproducing apparatus 100 records/reproduces information with respect to a holographic recording medium 7 having a reflective film 9.

An operation of holographic recording/reproducing apparatus 100 at the time of recording will firstly be described. Laser light 11 emitted from laser 1 is collimated by collimate lens 2, which is guided to spatial light amplitude modulator 3. Laser light 11 is split into a signal light 12 and a reference light 13 by spatial light amplitude modulator 3, and amplitude-modified as required in their respective areas. More specifically, signal light 12 undergoes intensity modulation by spatial light amplitude modulator 3 within the light flux of signal light 12. The pattern of such intensity modulation is generated based on data recorded on holographic recording medium 7. Reference light 13 may be a light having uniform intensity distribution or a light having undergone amplitude modulation.

Signal light 12 and reference light 13 pass through polarizing beam splitter 4 along a path 14, and converted to circularly polarized lights by quarter wave plate 5. Signal light 12 and reference light 13 converted to the circularly polarized lights are focused into holographic recording medium 7 by objective lens 6. The thus focused signal light 12 and reference light 13 interfere with each other in holographic recording medium 7, and the resultant interference fringes are recorded on holographic recording medium 7. Holographic recording medium 7 is of a rotary optical disk type, and has reflective film 9 provided on the surface opposite to the surface to which signal light 12 and reference light 13 enter.

An operation of holographic recording/reproducing apparatus 100 at the time of reproduction will now be described. At the time of reproduction, holographic recording/reproducing apparatus 100 generates only reference light 13 by spatial light amplitude modulator 3, without generating signal light 12. Reference light 13, which is linearly polarized, is converted into a circularly polarized light by quarter wave plate 5, and is focused into holographic recording medium 7 by objective lens 6. With irradiation of reference light 13, holographic recording/reproducing apparatus 100 generates a reproduction light in accordance with the information of the interference fringes recorded on holographic recording medium 7.

The reproduction light is guided to image pickup element 8 along a path 15. More specifically, the reproduction light passes through objective lens 6, and is converted from a circularly polarized light to a linearly polarized light by quarter wave plate 5. The reproduction light thus converted to the linearly polarized light is reflected by polarizing beam splitter 4, and guided to image pickup element 8. Image pickup element 8 detects the intensity distribution pattern of the reproduction light, and a reproduction signal of holographic recording medium 7 is generated from the detected image.

Holographic recording/reproducing apparatus 100 of the first embodiment controls the position and the area size of signal light 12 and/or reference light 13 in holographic recording medium 7 by means of spatial light amplitude modulator 3. Thus, holographic recording/reproducing apparatus 100 can set the position and the area size of signal light 12 and/or reference light 13 arbitrarily by using a spatial light amplitude modulator of high resolution as spatial light amplitude modulator 3. Further, by controlling the position of reference light 13 by spatial light amplitude modulator 3, holographic recording/reproducing apparatus 100 can change the incident angle on holographic recording medium 7. Angle multiplex recording can thus be realized.

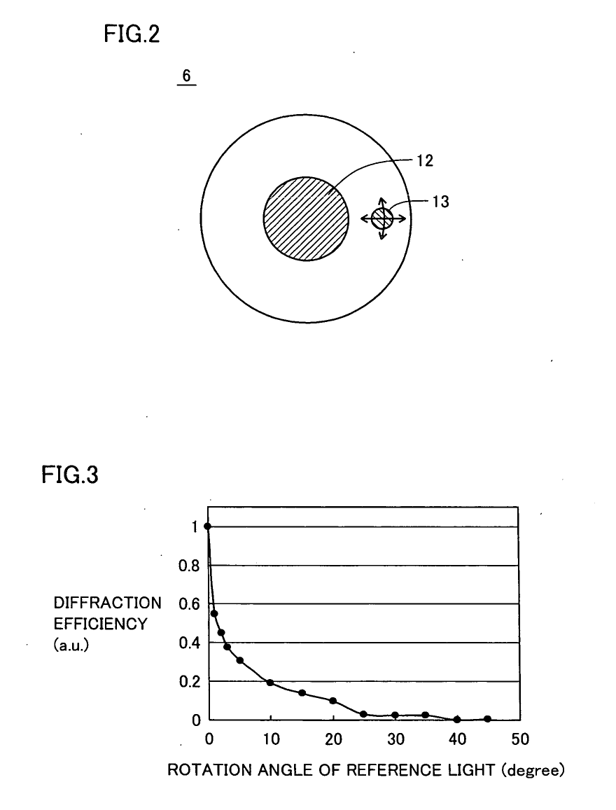

FIG. 2 shows the positional relationship between signal light 12 and reference light 13 in the pupil plane of objective lens 6 in holographic recording/reproducing apparatus 100 shown in FIG. 1. As shown in FIG. 2, when the position of reference light 13 is changed in a radial direction or a tangential direction in the pupil plane of objective lens 6, the angle between reference light 13 and signal light 12 (see FIG. 1) changes in holographic recording medium 7.

Meanwhile, signal light 12 and reference light 13 are focused on the same area within holographic recording medium 7 by objective lens 6. Therefore, holographic recording/reproducing apparatus 100 can perform angle multiplexing by only controlling the position of reference light 13. Further, when holographic recording medium 7 is moved in the XY in-plane direction, holographic recording can be carried out similarly in a different area of holographic recording medium 7. That is, holographic recording/reproducing apparatus 100 is capable of performing spatial shift multiplex recording as well. Accordingly, holographic recording/reproducing apparatus 100 of the first embodiment implements a combination of angle multiplexing and spatial shift multiplexing.

FIG. 3 shows a change in diffraction efficiency of the reproduction light when the position of reference light 13 is rotated in the radial direction in the pupil plane of objective lens 6. In FIG. 3, the change in diffraction efficiency in the case where the light fluxes of signal light 12 and reference light 13 are arranged in the pupil plane of objective lens 6 and the both light fluxes are focused on holographic recording medium 7 to perform holographic recording is shown.

FIG. 3 shows the results when objective lens 6 has a numerical aperture of 0.35, signal light 12 and reference light 13 each have a numerical aperture of 0.1, and holographic recording medium 7 has a thickness of 0.3 mm. As shown in FIG. 3, when the position of reference light 13 is rotated in the radial direction in the pupil plane of objective lens 6 at the time of reproduction by holographic recording/reproducing apparatus 100, diffraction efficiency of the reproduction light becomes approximately zero near the rotation angle of 30 degrees. This means that intensity of the reproduction light becomes approximately zero near 30 degrees. Thus, 12-multiplex recording is possible when rotating the position of reference light 13 in the radiation direction.

Referring to FIG. 1, when holographic recording medium 7 is of an optical disk type and spatial shift multiplexing is performed by rotation of holographic recording medium 7, holographic recording medium 7 vibrates in the Z direction during rotation. The optical pickup portion of holographic recording/reproducing apparatus 100 performs focusing servo control by an actuator so as to follow the vibration of the rotary optical disk in the Z direction. As such, even if there occurs vibration in the focusing direction, the superposed state of reference light 13 and signal light 12 in holographic recording medium 7 can be maintained, whereby accurate recording/reproduction of information is enabled. The focusing servo is carried out with respect to objective lens 6 or the entire optical pickup portion.

As described above, according to the holographic recording/reproducing apparatus of the first embodiment, recording of high density is possible by combing the angle multiplex recording and the spatial shift multiplex recording. Two light fluxes required for the angle multiplex recording are guided to the holographic recording medium by means of a common optical component such as an objective lens or a compound lens, which eliminates the need of positional adjustment of the two light fluxes. Further, by performing focusing servo on the integrated optical pickup portion, application to a rotary-type optical disk is facilitated.

### Second Embodiment

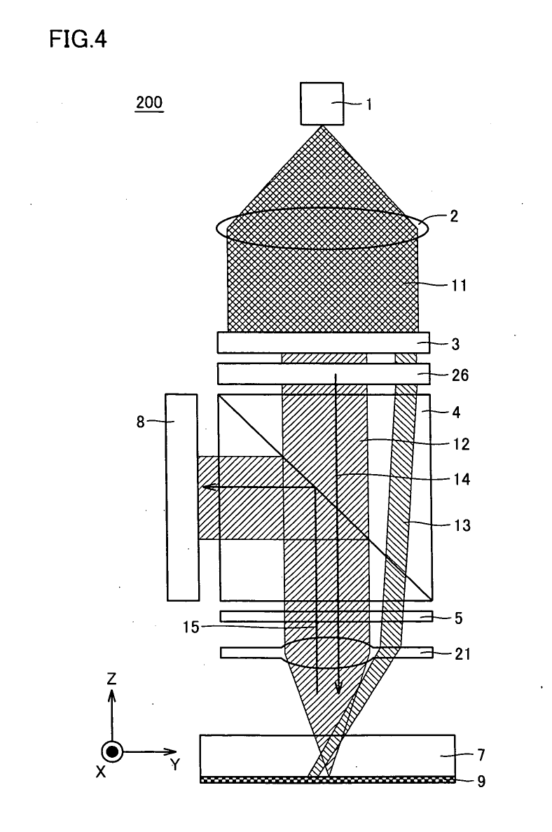

FIG. 4 is a cross sectional view showing a schematic configuration of a holographic recording/reproducing apparatus 200 according to the second embodiment of the present invention. Referring to FIG. 4, the holographic recording/reproducing apparatus (information recording/reproducing apparatus) 200 is identical to holographic recording/reproducing apparatus 100 of the first embodiment except that objective lens 6 is replaced with a compound lens 21, and a spatial light phase modulator 26 is additionally provided in the light path. Therefore, description of the common portions will not be repeated.

FIG. 5 shows positional relationship between signal light 12 and reference light 13 within the pupil plane of compound lens 21 in holographic recording/reproducing apparatus 200 shown in FIG. 4. Referring to FIG. 5, compound lens 21 includes a lens portion 21a arranged at the central portion and a diffraction grating portion 21b arranged at the peripheral portion. Lens portion 21a may be, e.g., a Fresnel lens. Diffraction grating portion 21b is preferably blazed.

An operation of holographic recording/reproducing apparatus 200 at the time of recording will now be described. Laser light 11 emitted from laser 1 is split into signal light 12 and reference light 13 by spatial light amplitude modulator 3, as explained in the first embodiment. Signal light 12 is focused into holographic recording medium 7 by lens portion 21a of compound lens 21. Reference light 13 is diffracted by diffraction grating portion 21b of compound lens 21, and guided to an area in holographic recording medium 7 that is irradiated with signal light 12. In this manner, interference fringes of signal light 12 and reference light 13 are formed in holographic recording medium 7, for holographic recording.

The diffraction grating formed at diffraction grating portion 21b has a grating pitch that is not uniform but becomes shorter as it approaches the periphery. The diffraction grating has its grating pitch set such that reference light 13 incident on diffraction grating portion 21b is diffracted toward the area in holographic recording medium 7 that is irradiated with signal light 12. Thus, reference light 13 generated by spatial light amplitude modulator 3 comes to interfere with signal light 12 in the vicinity of the focal point of signal light 12 in holographic recording medium 7.

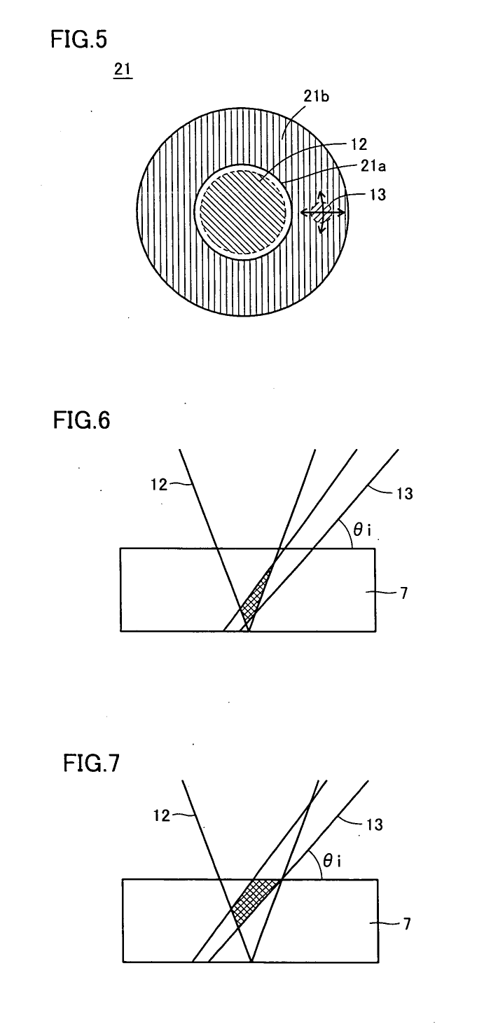

Holographic recording/reproducing apparatus 200 of the second embodiment can control the area of interference between signal light 12 and reference light 13 in the thickness direction of holographic recording medium 7 by controlling the phase of reference light 13 by spatial light phase modulator 26. As shown in FIG. 4, holographic recording/reproducing apparatus 200 can bend the traveling direction of reference light 13 by controlling the phase of reference light 13 by spatial light phase modulator 26. As such, the degree of freedom of the interference area of signal light 12 and reference light 13 increases, which will now be described with reference to FIGS. 6 and 7.

FIG. 6 shows by way of example how holographic recording medium 7 is irradiated with signal light 12 and reference light 13 in holographic recording/reproducing apparatus 200 shown in FIG. 4. Reference light 13 enters into holographic recording medium 7 at an angle θi. As shown in FIG. 6, when the phase modulation by spatial light phase modulator 26 is small, signal light 12 comes to interfere with reference light 13 near the focal point of signal light 12, and holographic recording is effected at the interference area.

FIG. 7 shows another example of irradiation of holographic recording medium 7 with signal light 12 and reference light 13 in holographic recording/reproducing apparatus 200 shown in FIG. 4. As shown in FIG. 7, when phase modulation effected by spatial light phase modulator 26 is strong, the position of reference light 13 incident at angle θi is shifted. As such, signal light 12 and reference light 13 come to interfere with each other at the area offset from the focal point of signal light 12, and holographic recording is effected at the relevant interference area.

As described above, the holographic recording/reproducing apparatus of the second embodiment is capable of freely controlling the incident position, size, and incident angle of the light flux of the reference light in the holographic recording medium, and thus, it can control the interference fringe forming area in the thickness direction of the holographic recording medium as well. As a result, it is possible to increase the recording density of the holographic recording medium.

### Third Embodiment

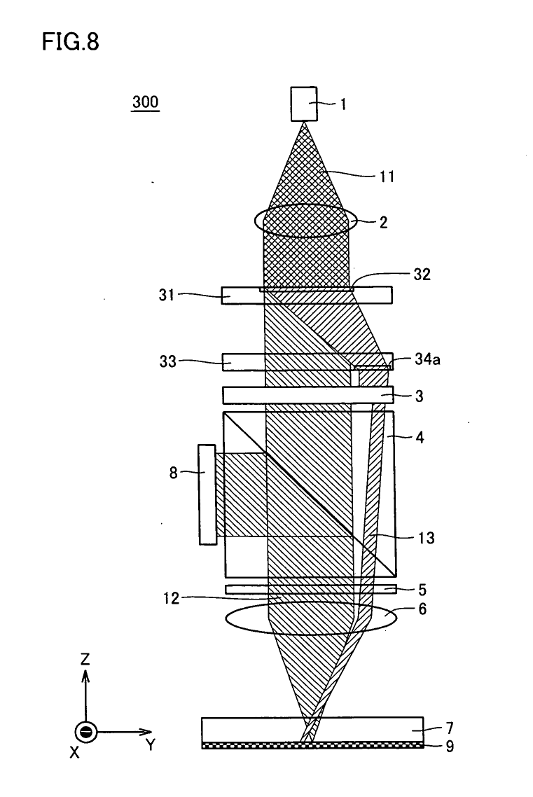

FIG. 8 is a cross sectional view showing a schematic configuration of a holographic recording/reproducing apparatus 300 according to the third embodiment of the present invention. Referring to FIG. 8, the holographic recording/reproducing apparatus (information recording/reproducing apparatus) 300 of the third embodiment is identical to holographic recording/reproducing apparatus 100 of the first embodiment except that diffracting elements 31, 33, which rotate about a Z axis, are additionally provided in the light path. Therefore, description of the common portions will not be repeated.

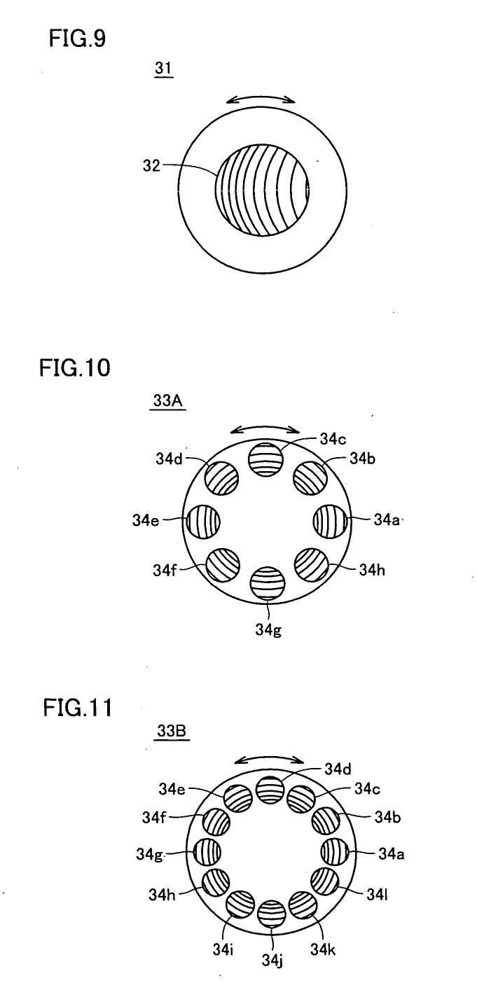

FIG. 9 is a top plan view showing a configuration of diffracting element 31 in holographic recording/reproducing apparatus 300 shown in FIG. 8. Referring to FIG. 9, diffracting element 31 includes a diffraction grating portion 32 that splits laser light 11 into signal light 12 and reference light 13.

The split ratio at this time is determined by designing of the cross section of the grating in diffraction grating portion 32. The grating with a blazed structure can increase the use efficiency of light. Signal light 12 is guided to holographic recording medium 7 along the path described in the first embodiment. Reference light 13 has its traveling direction bent by diffraction grating portion 32 to be guided to diffracting element 33.

FIG. 10 is a top plan view showing a configuration of a diffracting element 33A as an example of diffracting element 33 of FIG. 8. Referring to FIG. 10, diffracting element 33A includes eight diffraction grating patterns 34a, 34b, . . . , 34h. Diffraction gratings having different diffraction angles are formed in respective diffraction grating patterns 34a, 34b, . . . .

Reference light 13 guided to diffracting element 33A is diffracted by at least one of diffraction grating patterns 34a, 34b, . . . , and guided to spatial light amplitude modulator 3. Spatial light amplitude modulator 3 determines the position and the area size of signal light 12 and/or the diffracted reference light 13 in holographic recording medium 7. Signal light 12 and reference light 13 having passed through spatial light amplitude modulator 3 are guided to holographic recording medium 7 along the path described in the first embodiment. Diffraction grating 33A can change the diffraction angle in eight steps, and enables eight more multiplex recording in addition to the rotation of diffracting element 31 (12-multiplexing under the conditions shown in FIG. 3, for example).

FIG. 11 is a top plan view showing a configuration of a diffracting element 33B as another example of diffracting element 33 in FIG. 8. Referring to FIG. 11, diffracting element 33B includes 12 diffraction grating patterns 34a, 34b, . . . , 34l. With diffracting element 33B, the diffraction angle can be changed in 12 steps.

Holographic recording/reproducing apparatus 300 of the third embodiment can control the position of reference light 13 within the pupil plane of objective lens 6 by rotation of diffracting element 31 and by spatial light amplitude modulator 3. Further, it can control the incident angle and the incident position of reference light 13 on holographic recording medium 7 by selecting diffraction grating patterns 34a, 34b, . . . by rotating diffracting element 33.

Further, holographic recording/reproducing apparatus 300 can form the interference fringes of high contrast by optimizing the diffraction efficiency of diffraction grating portion 32 and by setting the ratio in energy density of signal light 12 and reference light 13 to 1:1 in the interference fringe forming area of holographic recording medium 7.

Holographic recording/reproducing apparatus 300 can control the interference area between signal light 12 and reference light 13 by controlling the irradiation position, size, incident angle of reference light 13 in holographic recording medium 7. As such, even with thick holographic recording medium 7, holographic recording/reproducing apparatus 300 can control the interference area in its thickness direction, to thereby improve recording density.

As described above, the holographic recording/reproducing apparatus of the third embodiment can control the position and the area size of the reference light and/or the signal light in various manners using the spatial light modulator, movable diffraction grating, movable mask mechanism, light shutter and the like. This can increase the degree of freedom in multiplex recording on the holographic recording medium.

### Fourth Embodiment

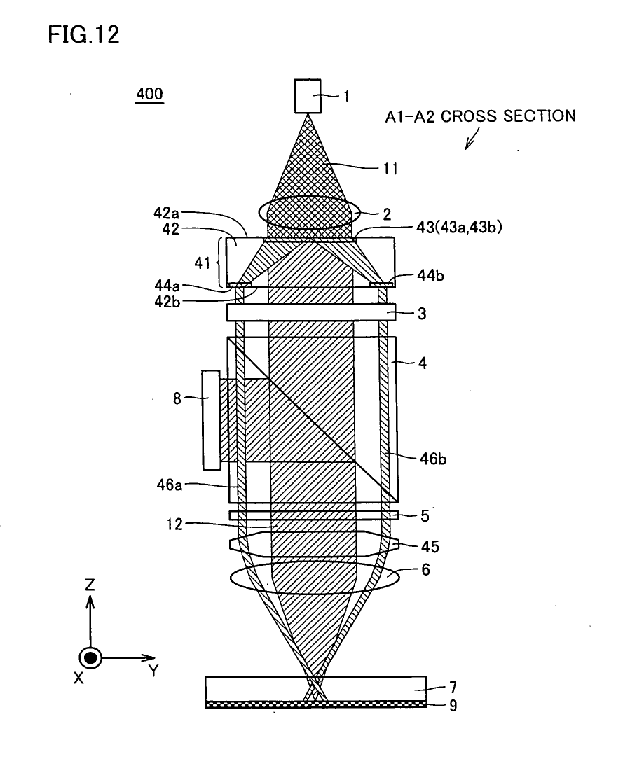

FIG. 12 is a cross sectional view showing a schematic configuration of a holographic recording/reproducing apparatus 400 according to the fourth embodiment of the present invention. Referring to FIG. 12, the holographic recording/reproducing apparatus (information recording/reproducing apparatus) 400 of the fourth embodiment is identical to holographic recording/reproducing apparatus 100 of the first embodiment except that a diffracting element 41 and a prism element (movable prism) 45 rotating around a Z axis are additionally provided in the light path. Therefore, description of the common portions will not be repeated. FIG. 12 is a cross sectional view showing the A1-A2 cross section in prism element 45 shown in FIG. 15.

Diffracting element 41 is arranged between collimate lens 2 and spatial light amplitude modulator 3. Diffracting element 41 includes diffraction gratings 43a, 43b (also collectively referred to as diffraction grating 43) arranged by halving the upper surface 42a of a transparent substrate 42, and diffraction gratings 44a, 44b arranged by halving the lower surface 42b. Prism element 45 is arranged between quarter wave plate 5 and objective lens 6, and has a prism angle changed gradually.

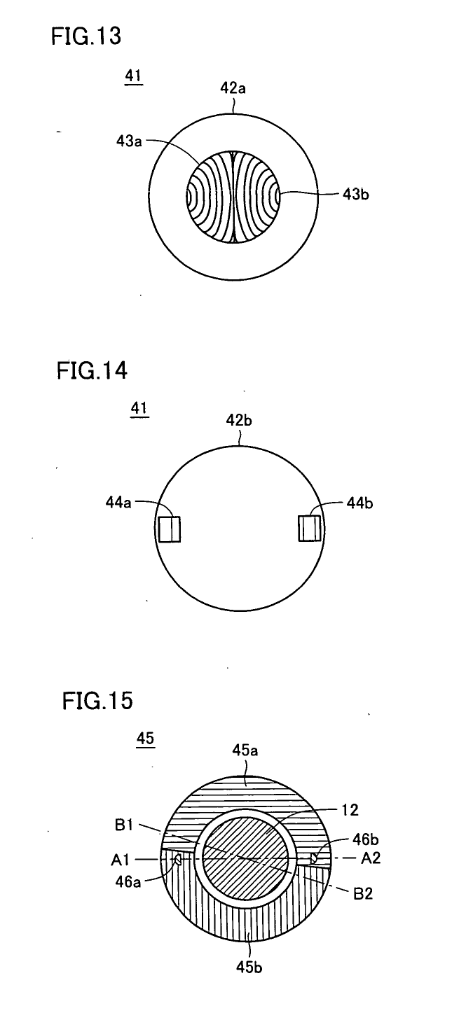

FIG. 13 is a top plan view showing a configuration of diffracting element 41 in holographic recording/reproducing apparatus 400 shown in FIG. 12. Referring to FIG. 13, diffracting element 41 includes halved diffraction gratings 43a, 43b at the central portion as seen from upper surface 42a. Referring to FIG. 12, diffraction grating 43 splits laser light 11 into signal light 12 and two reference lights 46a, 46b.

FIG. 14 is a bottom plan view showing the configuration of diffracting element 41 in holographic recording/reproducing apparatus 400 in FIG. 12. Referring to FIG. 14, diffracting element 41 includes halved diffraction gratings 44a, 44b at the peripheral portion as seen from lower surface 42b. Referring to FIG. 12, diffraction gratings 44a, 44b diffract reference lights 46a, 46b, respectively, to the Z axis direction parallel to signal light 12. Signal light 12 and reference lights 46a, 46b are guided to holographic recording medium 7 via spatial light amplitude modulator 3, prism element 45, objective lens 6 and others.

FIG. 15 is a top plan view showing a configuration of prism element 45 in holographic recording/reproducing apparatus 400 in FIG. 12. Referring to FIG. 15, prism element 45 has its central portion processed into a flat plate shape, through which signal light 12 passes. Further, the peripheral portion of prism element 45, through which reference lights 46a, 46b pass, is processed into a prism shape, and divided into two areas 45a, 45b, as shown in FIG. 15. Areas 45a, 45b are formed such that the prism angle gradually changes in each area.

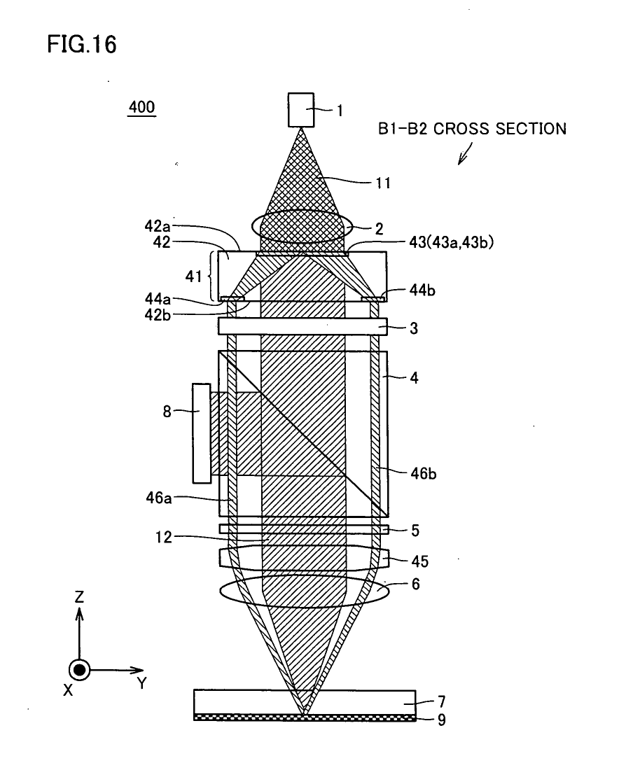

FIG. 16 is a cross sectional view showing a schematic configuration of holographic recording/reproducing apparatus 400 according to the fourth embodiment of the present invention. FIG. 16 is a cross sectional view showing the B1-B2 cross section in prism element 45 shown in FIG. 15. As shown in FIGS. 12 and 16, the refractive angles of reference lights 46a, 46b differ between the A1-A2 cross section and the B1-B2 cross section. Therefore, holographic recording/reproducing apparatus 400 of the fourth embodiment can control the refractive angles of reference lights 46a, 46b by rotating prism element 45 about the Z axis. As such, it is possible to control the incident angles and the incident positions of reference lights 46a, 46b on holographic recording medium 7.

In diffracting element 33 of the third embodiment, diffraction efficiency depends on the cross sectional shapes of diffraction grating patterns 34a, 34b, . . . . Thus, in order to achieve high efficiency in diffracting element 33, an optimal cross sectional shape is required for each of diffraction grating patterns 34a, 34b, . . . , which may complicate designing and fabrication of the diffracting element. By comparison, with prism element 45 of the fourth embodiment, optimization of the individual cross sectional shapes as described above is unnecessary. Thus, high efficiency in use of light can be realized without the need of complicated designing.

As described above, according to the holographic recording/reproducing apparatus of the fourth embodiment, the position and the incident angle of the reference light in the pupil plane of the objective lens can be controlled via control of the rotation of the diffracting element and the prism element about the signal light direction as the rotation axis, as well as via control by the spatial light amplitude modulator.

### First Through Fourth Embodiments

In the first through fourth embodiments, the irradiation position and the area size of the reference light may be controlled, not only by spatial light amplitude modulator 3, but also by a light flux control element that has an appropriate combination of the spatial light phase modulator, light shutter, movable diffraction grating, movable mask mechanism and the like. Further, the incident angle of the reference light on holographic recording medium 7 may be controlled by appropriately combining the spatial light amplitude modulator, spatial light phase modulator, diffracting element and the like. Further, although the case of using a transmitting-type spatial light modulator has been explained in the first through fourth embodiments, it may be a reflecting-type spatial light modulator.

In the first through fourth embodiments, although the reference light incident on holographic recording medium 7 may be plane wave, spatial shift multiplexing cannot be effected with the plane wave. Thus, at the time of performing the spatial shift multiplexing, a convergent light or a divergent light may be used for the reference light incident on holographic recording medium 7. The signal light incident on holographic recording medium 7 may also be a convergent light or a divergent light.

In the first through fourth embodiments, it is desirable that the holographic recording/reproducing apparatus is subjected to adjustment in light amount of the signal light and the reference light such that the energy densities of the respective light fluxes become equal to each other at the time of recording in the interference area of the signal light and the reference light in holographic recording medium 7.

Although the holographic recording/reproducing apparatus (information recording/reproducing apparatus) has been explained as an integrated type apparatus of recording and reproduction in the above embodiments, it is of course possible to form a holographic recording apparatus (information recording apparatus) and a holographic reproducing apparatus (information reproducing apparatus) separately from each other. In the holographic recording apparatus, image pickup element 8, for example, does not need to be provided. Further, in the holographic reproducing apparatus, spatial light modulator 3, for example, does not need to be provided.

Further, although one light flux for each of signal light 12 and reference light 13 has been explained in the first through third embodiments, a plurality of light fluxes may be provided for each of them. For example, the fourth embodiment describes the case where there are two light fluxes of the reference light. Furthermore, although the position and the size of the signal light have been fixed while the position and the area size of the reference light are changed, it is possible to change the position and the size of the signal light each time the control of the reference light is effected.

It is desirable that the angle between the signal light and the reference light is kept uniform so as to ensure constant intensity of the reproduction signal of holographic recording medium 7. It is possible to keep the intensity of the reproduction signal constant by controlling the position and the area size of the signal light in accordance with the control of the reference light. In doing so, the SN (Signal to Noise) ratio can be set high.

As explained above, the holographic recording/reproducing apparatuses of the first through fourth embodiments can control the position and the area size of the reference light or the signal light in various manners by using the spatial light amplitude modulator, movable diffraction grating, movable mask mechanism, light shutter, and the like. Further, it is possible to control the incident angle of the reference light on the holographic recording medium, and accordingly, the degree of freedom in multiplex recording on the holographic recording medium can be increased.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information recording apparatus recording information on a holographic recording medium, comprising:
a light flux control element splitting light emitted from a light source into a reference light and a signal light, and controlling a position and an area size of said reference light and/or a position and an area size of said signal light in said holographic recording medium; and
a lens guiding said signal light and said reference light to the same area of said holographic recording medium.

2. The information recording apparatus according to claim 1, further comprising a light deflecting element deflecting said reference light to control an interference position of said reference light and said signal light in said holographic recording medium.

3. An information recording apparatus recording information on a holographic recording medium, comprising:
a first diffracting element splitting light emitted from a light source into a reference light and a signal light;
a light flux control element controlling a position and an area size of said reference light and/or a position and an area size of said signal light in said holographic recording medium; and
a lens focusing said signal light and said reference light on the same area of said holographic recording medium.

4. An information reproducing apparatus reproducing information from a holographic recording medium, comprising:
a light flux control element forming a reference light by light emitted from a light source, and controlling a position and an area size of said reference light in said holographic recording medium; and
a lens guiding said reference light to said holographic recording medium.

5. The information reproducing apparatus according to claim 4, further comprising a light deflecting element deflecting said reference light to control an incident angle of said reference light on said holographic recording medium.

6. An information recording/reproducing apparatus recording/reproducing information with respect to a holographic recording medium, comprising:
a light flux control element splitting light emitted from a light source into a reference light and a signal light at the time of recording, and controlling a position and an area size of said reference light and/or a position and an area size of said signal light in said holographic recording medium; and
a lens guiding said signal light and said reference light to the same area of said holographic recording medium at the time of recording, and guiding said reference light to said holographic recording medium at the time of reproduction.

7. The information recording/reproducing apparatus according to claim 6, wherein said light flux control element includes at least one of a spatial light modulator, a light shutter, a movable diffraction grating, and a movable mask.

8. The information recording/reproducing apparatus according to claim 7, wherein
said movable diffraction grating has either one diffraction grating pattern rotated or moved, or a plurality of diffraction grating patterns, and
a desired diffraction grating pattern is selected therefrom by rotating said movable diffraction grating.

9. The information recording/reproducing apparatus according to claim 6, further comprising an actuator servo-controlling said lens in an optical axis direction in response to vibration of said holographic recording medium.

10. The information recording/reproducing apparatus according to claim 6, wherein
said lens includes
a lens portion arranged at a central portion, and
a diffraction grating portion arranged at a peripheral portion and having a grating pitch set to diffract said reference light toward an area in said holographic recording medium irradiated with said signal light.

11. The information recording/reproducing apparatus according to claim 6, further comprising a light deflecting element deflecting said reference light to control an interference position of said reference light and said signal light in said holographic recording medium.

12. The information recording/reproducing apparatus according to claim 11, wherein said light deflecting element includes at least one of a spatial light phase modulator, a movable diffraction grating, and a movable prism.

13. The information recording/reproducing apparatus according to claim 12, wherein
said movable diffraction grating has either one diffraction grating pattern rotated or moved, or a plurality of diffraction grating patterns, and
a desired diffraction grating pattern is selected therefrom by rotating said movable diffraction grating.

14. The information recording/reproducing apparatus according to claim 12, wherein said movable prism has a central portion through which said signal light passes processed into a flat plate shape, and a peripheral portion through which said reference light passes processed into a prism shape, and includes a plurality of areas in said peripheral portion having prism angles gradually changed.

15. The information recording/reproducing apparatus according to claim 6, wherein said reference light incident on said holographic recording medium is a convergent light or a divergent light.

16. The information recording/reproducing apparatus according to claim 6, wherein said reference light incident on said holographic recording medium is a plane wave.

17. The information recording/reproducing apparatus according to claim 6, wherein said signal light incident on said holographic recording medium is a convergent light or a divergent light.

18. An information recording/reproducing apparatus recording/reproducing information with respect to a holographic recording medium, comprising:
a first diffracting element splitting light emitted from a light source into a reference light and a signal light at the time of recording;
a light flux control element controlling a position and an area size of said reference light and/or a position and an area size of said signal light in said holographic recording medium; and
a lens focusing said signal light and said reference light on the same area of said holographic recording medium at the time of recording, and focusing said reference light on said holographic recording medium at the time of reproduction.

19. The information recording/reproducing apparatus according to claim 18, wherein said light flux control element is a spatial light amplitude modulator, and a position of said reference light in a pupil plane of said lens is controlled by rotation of said first diffracting element and by said spatial light amplitude modulator.

20. The information recording/reproducing apparatus according to claim 18, further comprising a second diffracting element including a plurality of diffraction grating patterns diffracting said reference light, wherein
said plurality of diffraction grating patterns are selected by rotating said second diffracting element, so as to control an incident angle and an incident position of said reference light on said holographic recording medium.

21. The information recording/reproducing apparatus according to claim 18, wherein said first diffracting element includes a diffraction grating portion having diffraction efficiency optimized such that energy densities of said signal light and said reference light become equal to each other in an interference fringe forming area of said holographic recording medium.

22. The information recording/reproducing apparatus according to claim 18, wherein
said first diffracting element splits the light emitted from said light source into first and second reference lights and said signal light at the time of recording,
said light flux control element is a movable prism having a central portion through which said signal light passes processed into a flat plate shape, and a peripheral portion through which said reference light passes processed into a prism shape, and including a plurality of areas in said peripheral portion having prism angles gradually changed, and
one of said gradually changing prism angles is selected by rotating said movable prism, so as to control incident angles and incident positions of said first and second reference lights on said holographic recording medium.
